(19) United States
(12) Patent Application Publication
(10) Pub. No.: US 2017/0322827 A1
(43) Pub. Date: Nov. 9, 2017

(54) TESTING AND BENCHMARKING FOR ENTERPRISE DATA CENTERS

(71) Applicant: Nutanix, Inc., San Jose, CA (US)

(72) Inventors: Gary Jeffrey Little, Chapel Hill, NC (US); Christopher Ryan Wilson, Morrisville, NC (US); George Alfred Dowding, Durham, NC (US); Hement Belbase, Raleigh, NC (US); Brent Chun, Rancho Palos Verdes, CA (US)

(21) Appl. No.: 15/588,487

(22) Filed: May 5, 2017

Related U.S. Application Data
(60) Provisional application No. 62/333,131, filed on May 6, 2016.

(51) Int. Cl. G06F 9/455; G06F 3/06; G06F 11/14; G06F 11/30; G06F 11/34

(52) U.S. Cl. CPC G06F 9/45558; G06F 11/301; G06F 3/0665; G06F 3/0689; G06F 11/3409; G06F 3/0619; G06F 11/1484; G06F 2009/45579; G06F 2009/45591; G06F 2201/815

(57) ABSTRACT

In some embodiments, a system for testing performance of a virtualization environment comprises host machines, wherein each of the host machines comprises a hypervisor, one or more user virtual machines (UVMs) and a virtual machine controller, and one or more virtual disks comprising a plurality of storage devices. The one or more virtual disks may be accessible by the virtual machine controllers, and the virtual machine controllers conduct I/O transactions with the one or more virtual disks. The system may receive a specification of a hardware configuration for a host machine and configure the virtualization environment to incorporate the host machine. The system may then select one or more qualification tasks for a test scenario, execute the qualification tasks in the test scenario, and monitor performance of the virtualization environment. The system may then calculate a score assessing how well the hardware configuration may perform in the virtualization environment.

### PRIORITY

This application claims the benefit, under 35 U.S.C. §119(e), of U.S. Provisional Patent Application No. 62/333,131, filed 6 May 2016, which is incorporated herein by reference.

### TECHNICAL FIELD

This disclosure generally relates to a testing framework and a benchmarking application for enterprise data centers.

### BACKGROUND

A “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources just like a real computer.

Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows one to run multiple virtual machines on a single physical machine, with each virtual machine sharing the resources of that one physical computer across multiple environments. Different virtual machines can run different operating systems and multiple applications on the same physical computer.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Furthermore, there are now products that can aggregate multiple physical machines, running virtualization environments to not only utilize the processing power of the physical devices to aggregate the storage of the individual physical devices to create a logical storage pool wherein the data may be distributed across the physical devices but appears to the virtual machines to be part of the system that the virtual machine is hosted on. Such systems operate under the covers by using metadata, which may be distributed and replicated any number of times across the system, to locate the indicated data. These systems are commonly referred to as clustered systems, wherein the resources of the group are pooled to provide logically combined, but physically separate systems.

### SUMMARY OF PARTICULAR EMBODIMENTS

Particular embodiments provide an architecture for implementing an automated testing framework and benchmarking application for enterprise-grade data centers. The testing framework is a downloadable VM with a user interface. Once installed, the testing framework can test and analyze several different systems and report comparable information. This application provides test scenarios that cover real-world use cases. These use cases may be highly applicable for hyperconverged platforms because they may demonstrate variations in areas such as performance, data integrity, and availability.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a clustered virtualization environment according to particular embodiments.

FIG. 1B illustrates data flow within a clustered virtualization environment according to particular embodiments.

FIG. 2 is a schematic illustrating different elements in the testing framework.

FIG. 3 illustrates a block diagram of a computing system suitable for implementing particular embodiments.

### DESCRIPTION OF EXAMPLE EMBODIMENTS

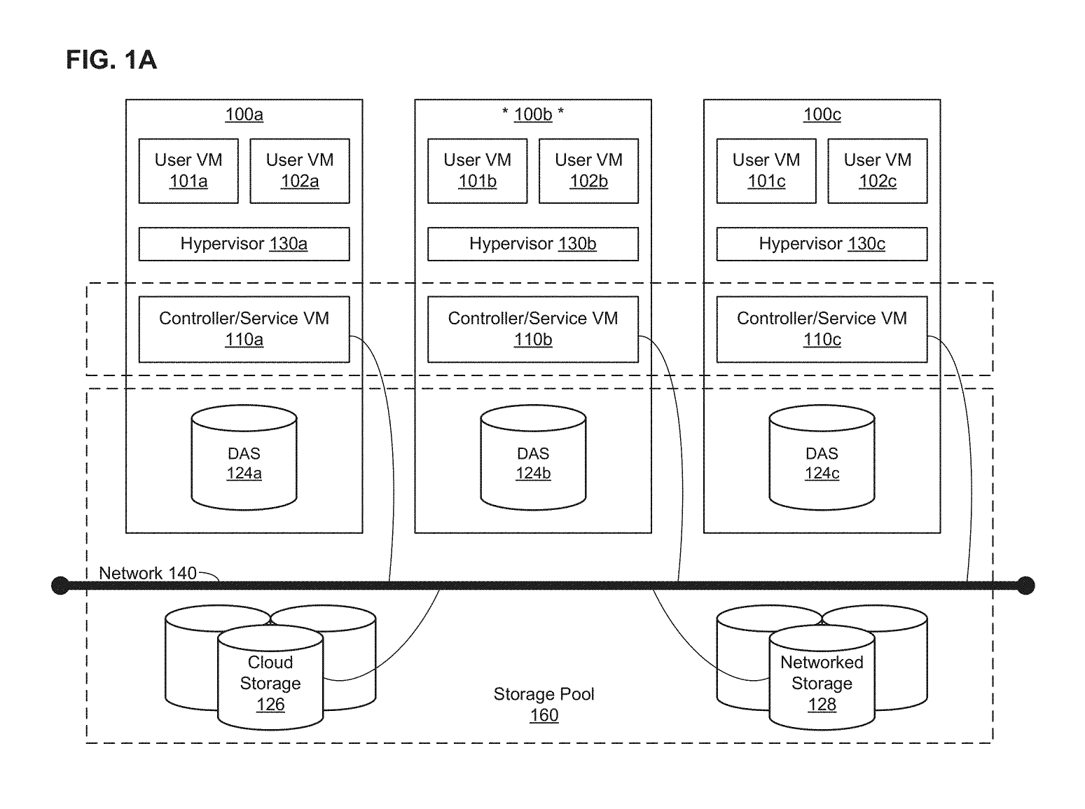

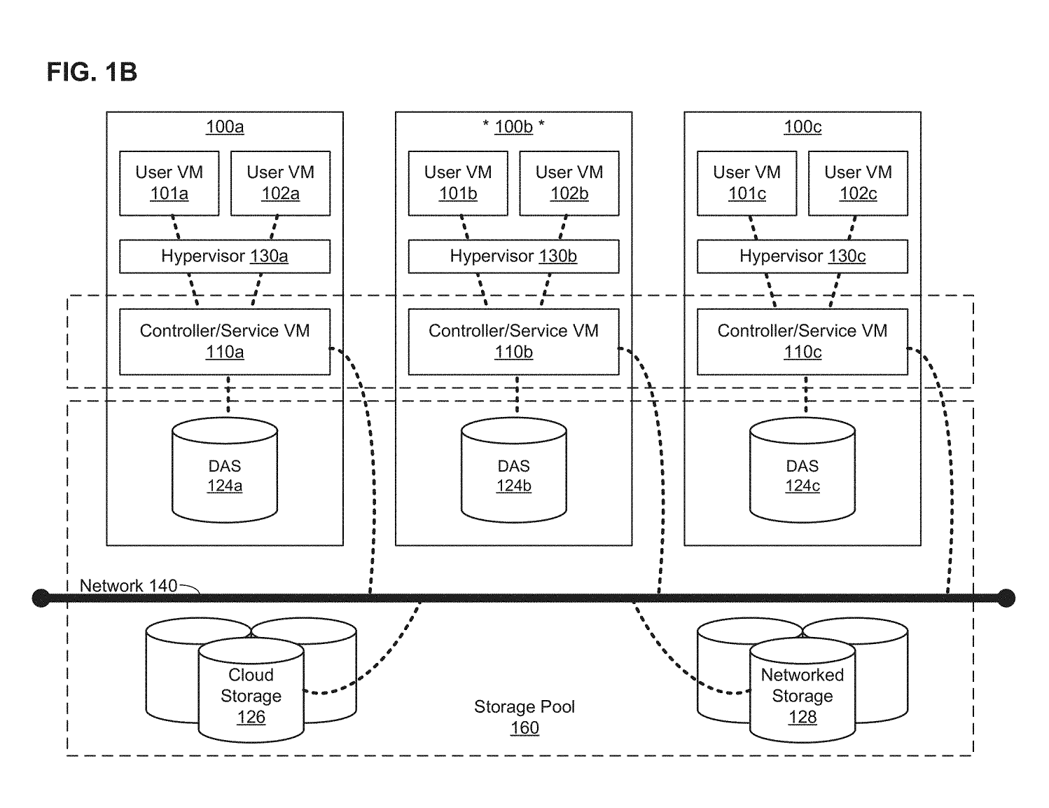

FIG. 1A illustrates a clustered virtualization environment according to particular embodiments. The architecture of FIG. 1A can be implemented for a distributed platform that contains multiple hardware nodes 100a-c that manage multiple tiers of storage. The multiple tiers of storage may include network-attached storage (NAS) that is accessible through network 140, such as, by way of example and not limitation, cloud storage 126, which may be accessible through the Internet, or local network-accessible storage 128 (e.g., a storage area network (SAN)). Unlike the prior art, the present embodiment also permits direct-attached storage (DAS) 124a-c that is within or directly attached to the server and/or appliance to be managed as part of storage pool 160. Examples of such storage include Solid State Drives (henceforth “SSDs”), Hard Disk Drives (henceforth “HDDs” or “spindle drives”), optical disk drives, external drives (e.g., a storage device connected to a hardware node via a native drive interface or a direct attach serial interface), or any other directly attached storage. These collected storage devices, both local and networked, form storage pool 160. Virtual disks (or “vDisks”) can be structured from the storage devices in storage pool 160, as described in more detail below. As used herein, the term vDisk refers to the storage abstraction that is exposed by a Controller/Service VM to be used by a user VM. In particular embodiments, the vDisk is exposed via iSCSI (“internet small computer system interface”) or NFS (“network file system”) and is mounted as a virtual disk on the user VM.

Each hardware node 100a-c runs virtualization software, such as VMWARE ESX(I), MICROSOFT HYPER-V, or REDHAT KVM. The virtualization software includes hypervisor 130a-c to manage the interactions between the underlying hardware and the one or more user VMs 101a, 102a, 101b, 102b, 101c, and 102c that run client software. Though not depicted in FIG. 1A, a hypervisor may connect to network 140.

Special VMs 110a-c are used to manage storage and input/output (“I/O”) activities according to particular embodiments, which are referred to herein as “Controller/Service VMs”. These special VMs act as the storage controller in the currently described architecture. Multiple such storage controllers coordinate within a cluster to form a single-system. Controller/Service VMs 110a-c are not formed as part of specific implementations of hypervisors 130a-c. Instead, the Controller/Service VMs run as virtual machines on the various hardware nodes 100, and work together to form a distributed system 110 that manages all the storage resources, including DAS 124a-c, networked storage 128, and cloud storage 126. The Controller/Service VMs may connect to network 140 directly, or via a hypervisor. Since the Controller/Service VMs run independent of hypervisors 130a-c, this means that the current approach can be used and implemented within any virtual machine architecture, since the Controller/Service VMs of particular embodiments can be used in conjunction with any hypervisor from any virtualization vendor.

A hardware node may be designated as a leader node. For example, hardware node 100b, as indicated by the asterisks, may be a leader node. A leader node may have a software component designated as a leader. For example, a software component of Controller/Service VM 110b may be designated as a leader. A leader may be responsible for monitoring or handling requests from other hardware nodes or software components on other hardware nodes throughout the virtualized environment. If a leader fails, a new leader may be designated. In particular embodiments, a management module (e.g., in the form of an agent) may be running on the leader node.

Each Controller/Service VM 110a-c exports one or more block devices or NFS server targets that appear as disks to user VMs 101a-c and 102a-c. These disks are virtual, since they are implemented by the software running inside Controller/Service VMs 110a-c. Thus, to user VMs 101a-c and 102a-c, Controller/Service VMs 110a-c appear to be exporting a clustered storage appliance that contains disks. All user data (including the operating system) in the user VMs 101a-c and 102a-c reside on these virtual disks.

Significant performance advantages can be gained by allowing the virtualization system to access and utilize DAS 124 as disclosed herein. This is because I/O performance is typically much faster when performing access to DAS 124 as compared to performing access to networked storage 128 across a network 140. This faster performance for locally attached storage 124 can be increased even further by using certain types of optimized local storage devices, such as SSDs. Further details regarding methods and mechanisms for implementing the virtualization environment illustrated in FIG. 1A are described in U.S. Pat. No. 8,601,473, which is hereby incorporated by reference in its entirety.

FIG. 1B illustrates data flow within an example clustered virtualization environment according to particular embodiments. As described above, one or more user VMs and a Controller/Service VM may run on each hardware node 100 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 160. Additionally or alternatively, Controller/Service VM 110a-c may present an emulated storage controller either to the hypervisor or to user VMs to facilitate I/O operations. Controller/Service 110a-c may be connected to storage within storage pool 160. Controller/Service VM 110a may have the ability to perform I/O operations using DAS 124a within the same hardware node 100a, by connecting via network 140 to cloud storage 126 or networked storage 128, or by connecting via network 140 to DAS 124b-c within another node 100b-c (e.g., via connecting to another Controller/Service VM 110b-c).

### Testing Framework

Availability: the framework tests how a hyperconverged solution tolerates a node failure during a workload. Consistent performance and stability tests the system's availability and the management fabric's failure tolerance.

Realistic Performance: the framework tests the system's solution to handle mixed workloads. The solution can include running databases on a single node, simultaneously running VDI workloads on multiple nodes, mixing VM snapshot, VDI boot storms, VM provisioning, and multiple workloads or stability over an extended period of time.

Network Utilization: this system also tests the network and bandwidth resources consumed for the user VMs where an ideal system receives little impact when backups and migrations occur to the cluster.

Feature Set: ideal features include clones for VM provisioning, deduplication, compression, VAAI support, native VM-level replication, Cloud connect, 1-click software and hypervisor upgrades, BIOS/drives, compatibility with multiple hypervisors and the ability to migrate and convert between hypervisors with the same solution.

Data integrity: this is key for any storage device or file system by avoiding loss or corruption. This application tests the data's safety during power outages or component failures.

### Test Scenarios

The test scenarios offer predefined test cases that consist of multiple events and predefined parameters. Test scenarios are executed against saved environments to run several analyses. The following scenarios use real world use cases to show clear and optimal results between Nutanix and competing products. The test scenarios use the Online Transaction Processing (OLTP), Virtual Desktop Infrastructure (VDI), and Decision Support System (DSS) workloads.

The framework may facilitate automated assessment of storage infrastructure under non-ideal conditions in a way that is repeatable, automated and provides a simple method to compare behavior between implementations. In an example embodiment, the framework may provide simulations of the three most intensive workloads, such as, by way of example and not limitation: transactional database, reporting database, and virtual desktops.

The framework may also provide simulations of the three most common datacenter workflows:
Single Host failure
Hypervisor upgrade reboot sequence
Creation of storage snapshots

The measurement is centered on the Transactional Database (DB) workload which is most sensitive to being perturbed by competing workloads, or the above datacenter workflows. The DB workload reaches a steady state and then the competing workloads or workflows are applied. The measurement is essentially how well the storage system is able to maintain a steady state in the face of the other workloads/workflows. This approach may provide a single measurement that can be used to compare Hyper-Converged storage implementations.

Particular embodiments combine three traditionally isolated tasks of scaled heterogeneous (many virtual machines performing different workloads at different times) workload generation, cross-component fault injection (hardware induced via OOB management, software induced via APIs), and aggregated (across the VMs) results analysis into single cross-platform repeatable test scenario. This reproducible process can then be used by non-experts to directly compare hyper-converged storage infrastructure.

In some cases, automation may be implemented using collections of ad-hoc scripts that have been cobbled together. These scripts have to be built for each use case, are typically hard to maintain, provide poor error handling, and introduce significant overhead.

Particular embodiments may provide a library within the framework. The library a may provide or support an extensible, general-purpose automation infrastructure. The infrastructure may enable construction and execution of hierarchical workflows comprising tasks which may be run sequentially and/or in parallel. Such workflows may be configurable to include nested execution of tasks and/or recursive execution of one or more tasks. The framework may be extensible by way of specifying actions for the tasks using plugins, so as to facilitate ease of adding on additional actions.

The infrastructure may further provide one or more libraries to provide functions, such as standardized error handling, logging and reporting, a common library of useful functionality, and other features.

The infrastructure has a pluggable framework may enable new workflows to be easily supported and integrated.

Particular embodiments may provide unified, standardized, automated hyperconverged platform qualification by way of a user interface-driven tool that can run standardized qualification tasks and procedures in a completely or partially automated manner. The qualification tasks and/or workflows may be designed to discover errors, performance issues, and verify functionality or behavior. Tasks may be designed to simulate realistic workloads for hyperconverged clients for any purpose, such as benchmarking and testing.

Inputs to the workflow execution engine may include selection of one or more test plans and information regarding the hardware platform. The tool may display progress indicators (during execution of the qualification tasks or procedures), as well as intermediate and/or final results (such as logs, graphs, tables, charts, and failure indicators).

Particular embodiments may provide a score representing an assessment of how well a particular hardware configuration will work with a platform providing a virtualized data center environment. End users may want to know how well their hardware will work with our platform, which is a complex question to answer due to the spectrum of storage workloads (e.g., bandwidth vs. TOPS) and the fact that every operation through the storage stack has a CPU cost as well. In order to estimate how well a given platform would perform, particular embodiments may either (1) quantify ideal ratios of compute and storage performance for a given workload and combine it with synthetic platform benchmarks, or (2) run a simulation that approximates a given workload through our entire stack. In particular embodiments, the score may be provided as a qualitative assessment on a scale ranging from low (e.g., “barely functional on this platform”) to high (which may be determined based on the best performing platform currently available). In particular embodiments, to capture the intricacies of combined workloads, the user may enter a percentage breakdown of various types of workloads they intend to run. Various simulations may be run at the indicated percentages, and a composite score may be provided for the platform.

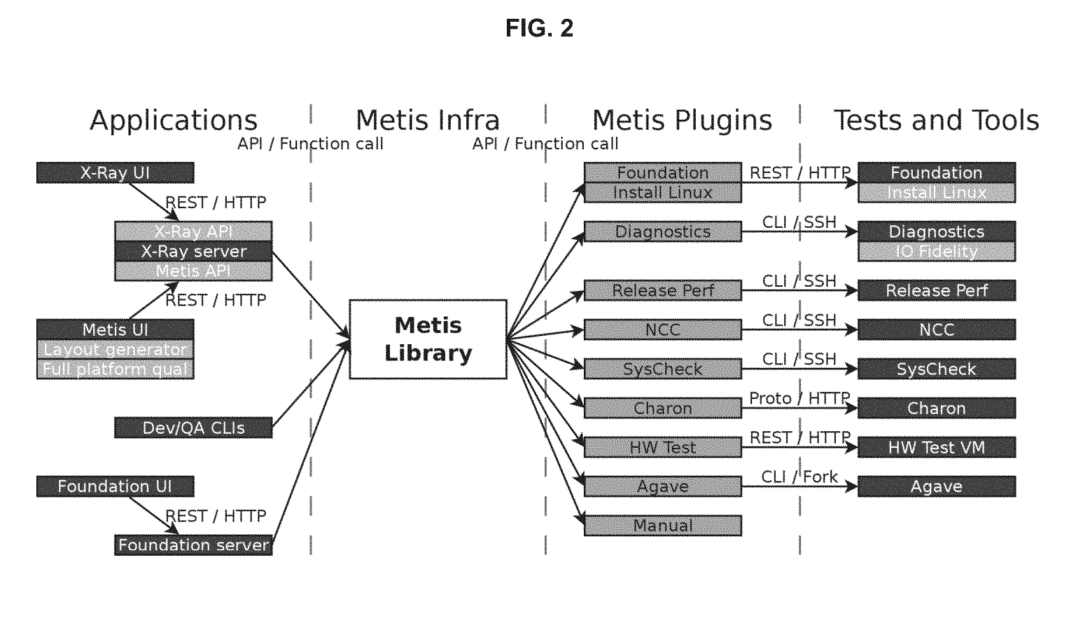

FIG. 2 is a schematic illustrating different elements in the testing framework. Different applications in the testing framework may provide user interfaces (UIs) through which different test scenarios may be created, tasks and processes selected, progress monitored, and final results displayed. The framework library may provide an API to handle interactions with the applications in the testing framework as well as providing an API to handle interactions with underlying tests and tools, which may be provided by way of a set of plugins.

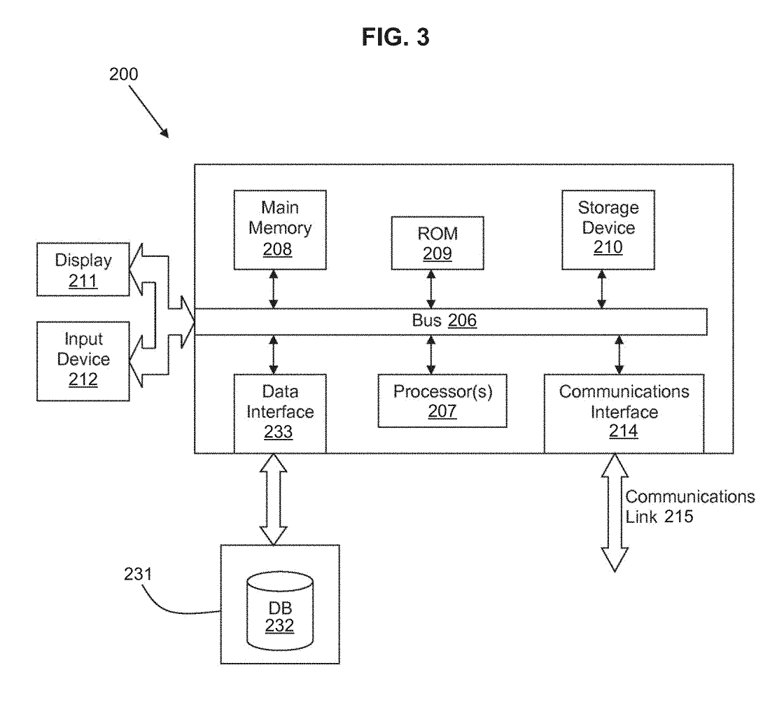

FIG. 3 is a block diagram of an illustrative computing system 200 suitable for implementing particular embodiments. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, a laptop or notebook computer system, a tablet computer system, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

Computer system 200 includes a bus 206 (e.g., an address bus and a data bus) or other communication mechanism for communicating information, which interconnects subsystems and devices, such as processor 207, system memory 208 (e.g., RAM), static storage device 209 (e.g., ROM), disk drive 210 (e.g., magnetic or optical), communication interface 214 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), display 211 (e.g., CRT, LCD, LED), input device 212 (e.g., keyboard, keypad, mouse, microphone). In particular embodiments, computer system 200 may include one or more of any such components.

According to particular embodiments, computer system 200 performs specific operations by processor 207 executing one or more sequences of one or more instructions contained in system memory 208. Such instructions may be read into system memory 208 from another computer readable/usable medium, such as static storage device 209 or disk drive 210. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 207 for execution. Such a medium may take many forms, including but not limited to, nonvolatile media and volatile media. Non-volatile media includes, for example, optical or magnetic disks, such as disk drive 210. Volatile media includes dynamic memory, such as system memory 208.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In particular embodiments, execution of the sequences of instructions to practice the invention is performed by a single computer system 200. According to other embodiments of the invention, two or more computer systems 200 coupled by communication link 215 (e.g., LAN, PTSN, or wireless network) may perform the sequence of instructions required to practice the invention in coordination with one another.

Computer system 200 may transmit and receive messages, data, and instructions, including program, i.e., application code, through communication link 215 and communication interface 214. Received program code may be executed by processor 207 as it is received, and/or stored in disk drive 210, or other non-volatile storage for later execution. A database 232 in a storage medium 231 may be used to store data accessible by the system 200 by way of data interface 233.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system for testing performance of a virtualization environment, comprising:
a plurality of host machines, wherein each of the host machines comprises a hypervisor, one or more user virtual machines (UVMs) and a virtual machine controller;
one or more virtual disks comprising a plurality of storage devices, the one or more virtual disks being accessible by the virtual machine controllers, wherein the virtual machine controllers conduct I/O transactions with the one or more virtual disks,
wherein the system is further operable to:
receive a specification of a hardware configuration for a host machine;
configure the virtualization environment to incorporate the host machine;
select one or more qualification tasks for a test scenario;
execute the qualification tasks in the test scenario;
monitor performance of the virtualization environment; and
calculate a score assessing how well the hardware configuration may perform in the virtualization environment.
